(19) United States
(12) Patent Application Publication
(10) Pub. No.: US 2024/0305029 A1
(43) Pub. Date: Sep. 12, 2024

(54) ELECTRICAL CONTACT ELEMENT AND DEVICE WITH A CONTACT ELEMENT OF THIS KIND

(71) Applicant: Vitesco Technologies GmbH, Regensburg (DE)

(72) Inventors: Jürgen Luttner, München (DE); Christian Lammel, München (DE)

(21) Appl. No.: 18/599,765

(22) Filed: Mar. 8, 2024

(30) Foreign Application Priority Data
Mar. 10, 2023 (DE) 10 2023 202 191.9

(51) Int. Cl. H01R 13/04; H01R 12/57

(52) U.S. Cl. CPC H01R 13/04; H01R 12/57

(57) ABSTRACT

An electrical contact element is disclosed. The contact element includes: a housing with an upper surface, a lower surface opposite the upper surface, and a side surface connecting the upper surface to the lower surface, a lower row of electrical connection pins protruding from the side surface, and an upper row of electrical connection pins protruding from the side surface. In the viewing direction perpendicular to the side surface, the connection pins of the upper row are arranged offset from the connection pins of the lower row and, in the viewing direction parallel to the side surface and along the upper or lower row of connection pins, the connection pins of the upper row intersect with the connection pins of the lower row.

### CROSS REFERENCE TO RELATED APPLICATIONS

This application claims priority to German Patent Application No. 10 2023 202 191.9, filed Mar. 10, 2023, the contents of such application being incorporated by reference herein.

### FIELD OF THE INVENTION

The present invention relates to an electrical contact element and to a device having a contact element of this kind.

### BACKGROUND OF THE INVENTION

Electrical contact elements are usually used for electrical contacting with an electrical contact carrier, such as a printed circuit board for example. Contact elements of this kind usually have one or more rows of connection pins (pins) which are electrically connected to the contact carrier.

Contact elements of this kind are usually placed on the electrical contact carrier by means of mechanical methods and then electrically connected to the electrical contact carrier. However, it has been shown that, despite mechanical support, faults can occur in the electrical connection between the respective connection pins of the contact element and the electrical contact carrier.

### SUMMARY OF THE INVENTION

An aspect of the present invention is provide an electrical contact element that allows a more reliable electrical connection to an electrical contact carrier.

According to a first aspect of the present invention, an electrical contact element is provided. The electrical contact element is used for electrical contacting with an electrical contact carrier, such as a printed circuit board for example. The electrical contact element can be a plug element, such as a plug connector, in particular a plug connector for, for example, a battery management system (BMS) of a vehicle. However, the electrical contact element may also be an electronic component having a controller chip and/or an ASIC chip. The electrical contact element according to the invention comprises a housing which has a lower surface, an upper surface opposite the lower surface, and a side surface connecting the lower surface to the upper surface. The housing is preferably substantially rectangular and/or cuboidal. The electrical contact element according to the invention further comprises a lower (first) row of electrical connection pins protruding from the side surface and an upper (second) row of electrical connection pins protruding from the same side surface. Connection pins of this kind can also be referred to as pins. The designations lower row and upper row relate to the distance from the lower surface of the housing. In other words, the lower row of electrical connection pins is arranged closer to the lower surface than the upper row of electrical connection pins. According to the invention, the electrical connection pins of the electrical contact element are arranged offset from each other in the viewing direction perpendicular to the side surface. More specifically, the connection pins of the upper row are arranged offset from the connection pins of the lower row by an offset distance, which is also known as pitch. In the contact element according to the invention, the connection pins of the upper row and the connection pins of the lower row, as considered in the viewing direction parallel to the side surface and along the upper or lower row of connection pins, are now arranged in such a way that the connection pins of the upper row intersect with the connection pins of the lower row.

The electrical contact element according to the invention is based at least in part on the knowledge that, in the case of electrical contact elements, the upper row of electrical connection pins usually protrudes further from the side surface than the lower row of electrical connection pins. To date, this arrangement has been chosen to ensure a predetermined creepage distance between electrical contact surfaces of connection pins closest to each other. However, a non-crossed arrangement of this kind leads to the connection pins of the upper row being considerably longer than the connection pins of the lower row. Within the scope of this invention, it has been recognized that comparatively long connection pins can, however, be detrimental during mounting of the electrical contact element. In particular, it has been recognized that, owing to the comparatively long connection pins of the upper row, it is not always possible to guarantee that the contact surfaces of the connection pins of the upper row and the contact surfaces of the connection pins of the lower row are arranged in the same plane. It has been recognized that, owing to the lack of coplanarity between the contact surfaces of the connection pins of the upper row and the contact surfaces of the connection pins of the lower row, insufficient or faulty electrical contacting to the respective contact surfaces and the electrical contact carrier can now occur during mounting of the electrical contact element on the electrical contact carrier. The electrical contact element according to the invention is based on the recognition that the connection pins of the upper row intersecting with the connection pins of the lower row leads to the total length of the connection pins of the upper row being able to be considerably shortened compared to a non-crossed arrangement. It has been recognized that shortening the connection pins of the upper row makes it easier to achieve the coplanarity of the electrical contact surfaces of the upper and lower connection pins. It has been recognized that a relatively short pin has greater stiffness compared to a relatively long connection pin and therefore a higher positional accuracy, this making it easier to meet the criterion for coplanarity. The improved coplanarity means that the number and quality of sufficiently good contacting operations can be increased when the electrical contact element is placed on the electrical contact carrier and during the subsequent electrical contacting with the electrical contact carrier. The contact element according to the invention thus contributes to improved electrical contacting with the electrical contact carrier being able to be achieved.

A preferred refinement of the contact element according to the invention provides that the electrical connection pins of the upper row and the electrical connection pins of the lower row each have an electrical contact surface for electrical contacting with an electrical contact carrier, such as a printed circuit board for example, and are arranged in such a way that a creepage distance between the electrical contact surface of a connection pin and the electrical contact surface of the closest connection pin is greater than an offset distance, measured parallel to the side surface, between a connection pin of the upper row and an adjacently arranged connection pin of the lower row. The offset distance between adjacent connection pins of the upper and lower row is the abovementioned pitch. The minimum creepage distance between two closest connection pins of an electrical contact element is determined, among other things, by the required creepage current resistance which the electrical contact element has to adhere to. The creepage distance is the distance between adjacent live parts (in this case the electrical contact surfaces of the connection pins) along the surface of the electrical contact carrier. It has been recognized that the connection pins intersecting above the contact carrier while maintaining a predetermined creepage distance has no adverse effect on the creepage current resistance of the electrical contact element. Nevertheless, the connection pins intersecting allows the abovementioned coplanarity of the electrical contact surfaces, so that an electrical connection of the electrical contact element to an electrical contact carrier can be made more reliably.

A further preferred refinement of the electrical contact element according to the invention provides that the connection pins of the upper row and the connection pins of the lower row each have a first pin portion which extends, in particular extends perpendicularly, from the side surface, a second pin portion which is connected to the first pin portion and extends substantially in the direction of the lower surface of the housing, and a third pin portion connected to the second pin portion, wherein the third pin portion is designed for electrically contacting the connection pin with an electrical contact carrier, such as a printed circuit board for example. This preferred refinement provides that the connection pins of the electrical contact element are ultimately formed in three parts. The first pin portion protrudes from the side surface, the second pin portion extends substantially in the direction of the lower surface of the housing, that is to say the contact carrier, and the third pin portion serves for electrical contacting with the contact carrier. The connection pins are preferably bent and shaped parts, so that the individual pin portions can, for example, merge with each other via curved portions with predetermined bending radii.

In the case of three-part connection pins—as considered in the viewing direction parallel to the side surface and along the upper or lower row—the second pin portions of the upper row intersect with the first pin portions of the lower row. In other words, those portions of the connection pins of the upper row which extend substantially in the direction toward the lower surface of the housing intersect with those portions of the connection pins of the lower row which extend substantially from the side surface.

The respective third pin portion preferably runs parallel to the respective first pin portion in the respective connection pin. In other words, the respective connection pins have a substantially Z-shaped form.

A preferred refinement provides that, measured in the direction perpendicular to the side surface or in the perpendicular direction to the side surface, a distance between an end side of the third pin portion and the side surface is greater than a maximum distance between the second pin portion and the side surface. This preferred refinement is based at least partially on the recognition that a test process that checks the electrical contacting usually has to be performed after the electrical contact element is mounted on the electrical contact carrier. Test processes of this kind are usually optical test processes which are performed from above, that is to say in the direction from the upper surface to the lower surface of the housing. Optical test processes of this kind can cause shading effects. In particular, the connection pins of the upper row can shade regions and in particular the electrical contact surface of the connection pins of the lower row, as a result of which the optical test process cannot be carried out as desired. In the preferred refinement, the end side of the third pin portion, that is to say of the pin portion which has the electrical contact surface, is further away from the side surface than the second pin portion of the respective connection pin. In particular in the case of the connection pins in the upper row, this leads to the third pin portions of the connection pins of upper row not being covered by the first pin portions of the connection pins of the upper row. This avoids shading problems in the case of optical test processes.

A further preferred refinement provides that, measured in the direction perpendicular to the side surface or in the perpendicular direction to the side surface, a distance between the side surface and an end side of the third pin portion of a connection pin of the lower row is greater than a maximum distance between the side surface and the second pin portion of a connection pin of the upper row. This preferred refinement is based at least partially on the recognition that connection pins of the upper row, in the case of an optical test process carried out from above, can shade the connection pins of the lower row, and there in particular their contact surfaces. However, by way of the end side of the third pin portion of a connection pin of the lower row being arranged further away from the side surface than a maximum distance between the side surface and the second pin portion of a connection pin of the upper row, this shading problem is avoided in optical test processes.

A further particularly preferred refinement provides that, measured in the direction perpendicular to the side surface or in the perpendicular direction to the side surface, a distance between the second pin portion and the side surface decreases in the direction toward the lower surface of the housing. In other words, in this particularly preferred refinement, the second pin portion is closer to the side surface of the housing at the lower end or in a region closer to the lower surface of the housing than in the upper region of the second pin portion. In simple terms, the connection pin has an “overbent Z-shape” in this particularly preferred refinement. In yet other words, a respective inner angle between the first and the second pin portion or between the second and third pin portion is less than 90°. A refinement of this kind also has the advantage of a smaller installation space since the lower ends of the upper connection pins move closer to the side surface. In the case of a specified minimum creepage distance, the connection pins of the lower row can therefore also move closer to the side surface, as a result of which the installation space for the contact element is reduced. It is of course possible that connection pins of the upper and/or the lower row can have an “overbent Z-shape” of this kind.

It is particularly preferred when the contact surface of the connection pins of the upper row and the contact surface of the connection pins of the lower row lie in a common plane.

According to a further aspect of the present invention, a device, in particular an electrical device, is provided, which comprises an electrical contact element according to the first aspect or refinements thereof and an electrical contact carrier which is electrically connected to the connection pins of the electrical contact element. The connection pins and in particular their electrical contact surfaces are preferably soldered to the electrical contact carrier. Soldering can be performed, for example, in a SMD process or in a pin-to-paste process. Other contact processes are of course possible.

### BRIEF DESCRIPTION OF THE DRAWINGS

Further features and objects of the present invention will become apparent to a person skilled in the art by practising the present teaching and taking into consideration the accompanying drawings. In the drawings:

FIG. 1 shows a first side view of a device having one embodiment of a contact element according to the invention,

FIG. 2 shows a second side view of the device of FIG. 1, FIG. 3 shows a schematic top view of the device of FIG. 1,

FIG. 4 shows a schematic side view of a device having a further embodiment of the contact element according to the invention, and

FIG. 5 shows a schematic sectional view of the device of FIG. 4.

Elements with the same function or construction are provided with the same reference signs throughout the figures.

### DETAILED DESCRIPTION OF THE PREFERRED EMBODIMENTS

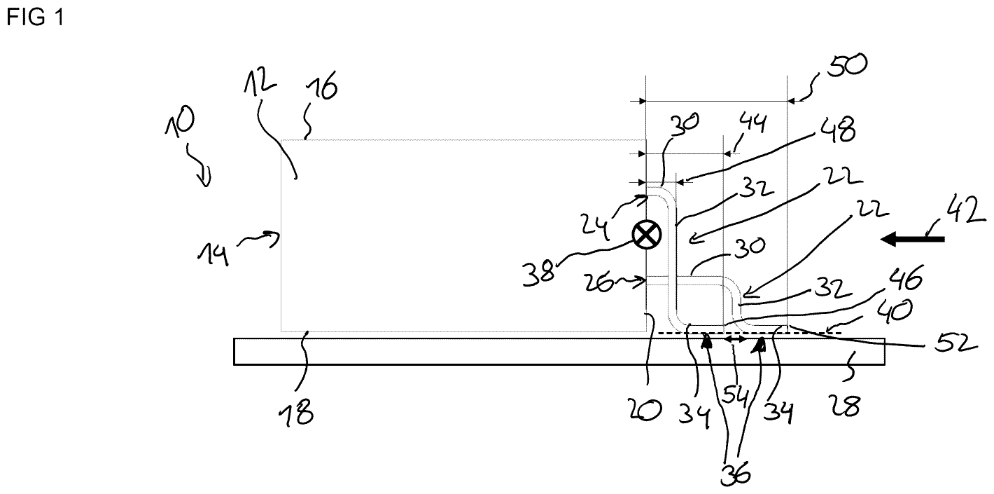

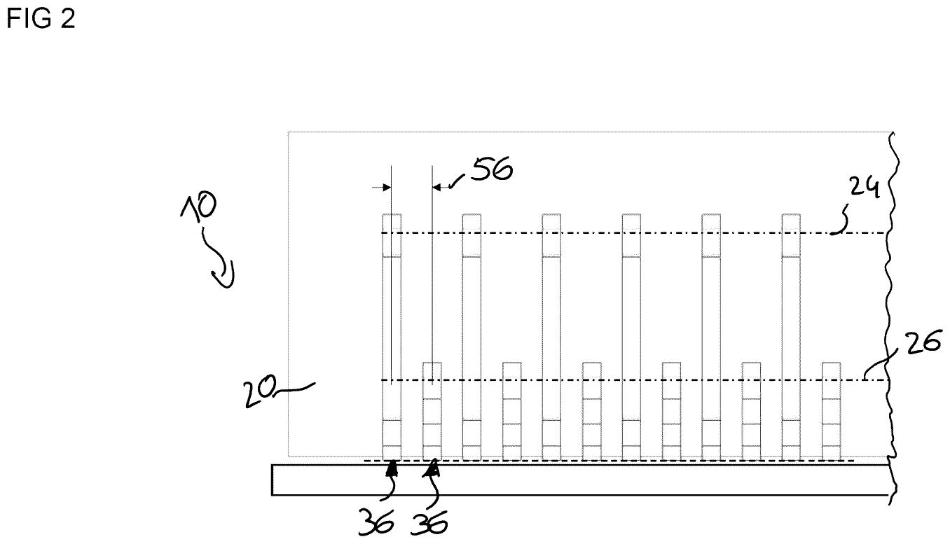

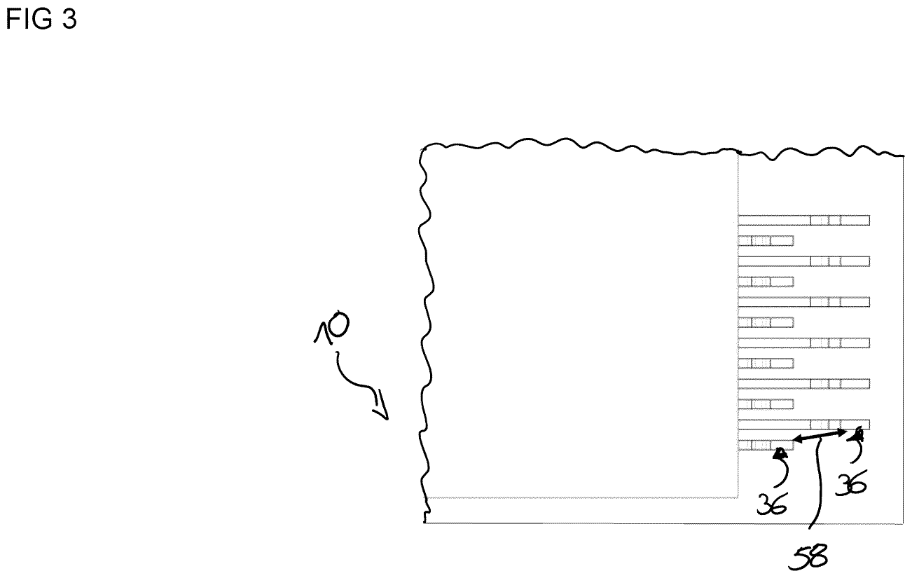

Reference will first of all be made to FIG. 1 which shows a side view of a device 10 having a variant of a contact element 12 according to the invention. The contact element 12 comprises a housing 14 with an upper surface 16, a lower surface 18 opposite the upper surface 16, and a side surface 20 connecting the upper surface 16 to the lower surface 18. In the specific example of FIG. 1, the housing 14 is a substantially rectangular or cuboidal housing, as is usually the case for contact elements of this kind. Two rows of connection pins 22 (pins) protrude from the side surface 20: a first or upper row 24 and a second or lower row 26. The rows 24, 26 extend along a straight line, as can be seen more closely in conjunction with FIG. 2. The upper row 24 and the lower row 26 can have an equal number or a different number of connection pins 22. The electrical connection pins 22 are used for electrical contacting with an electrical contact carrier 28, which can be a printed circuit board for example. The connection pins 22 can be bent-and-shaped parts, which can be bent into a shape suitable for the respective application.

In the specific example of FIG. 1, each of the connection pins 22 of the upper and the lower row 24, 26 has three pin portions. A first pin portion 30 extends from the side surface 20. A second pin portion 32, connected to the first pin portion 30, extends substantially from the upper surface 16 to the lower surface 18 of the housing 14. The second pin portion 32 is connected to a third pin portion 34, which serves for electrical contacting with the electrical contact carrier 28. In the specific exemplary embodiment of FIG. 1, the third pin portion 36 and the first pin portion 30 are arranged parallel to each other. The third pin portion 36 has an electrical contact surface 36 for the electrical connection of the connection pin 22 to the electrical contact carrier 28. An electrical connection can be made by soldering.

FIG. 1 shows the device 10 in a viewing direction parallel to the side surface 20 and along the upper or lower row 24, 26 of connection pins 22. The viewing direction parallel to the side surface 20 and along the upper or lower row 24, 26 is indicated by the symbol 38. As can be clearly seen in FIG. 1, the connection pins 22 of the upper row 24 intersect with the connection pins 22 of the lower row 26 as considered in the viewing direction 30. Specifically, the second pin portions 32 of the connection pins 22 of the upper row 24 intersect with the first pin portions 30 of the connection pins 22 of the lower row 26. The connection pins 22 intersecting can reduce the total length of the connection pins 22 of the upper row 24 compared to a non-crossing arrangement. Relatively short pins 22 are stiffer than relatively long pins 22. This makes it possible to ensure a higher degree of positional accuracy of the connection pins 22. In addition, the connection pins 22 of the upper and lower row 24, 26 are designed in such a way that the respective contact surfaces 36 are in a common plane 40. This coplanarity of the contact surfaces 36 is necessary to, for example, ensure machine-assisted electrical contacting of the contact surfaces 36 with the electrical contact carrier 28. If, for example, in a SMD process, the electrical contact element 12 is placed on the electrical contact carrier 28 and then soldered to the contact carrier 28, it is necessary and helpful if the contact surfaces 36 have a sufficient coplanarity. Otherwise, missoldering, which should be avoided, may occur during the soldering process.

As further shown in FIG. 1, a distance 44, measured in the perpendicular direction (arrow 42), between the side surface 20 and an end side 46 of the third pin portion 34 of the connection pin 22 of the upper row 24 is greater than a distance 48, measured in the perpendicular direction (arrow 42), between the side surface 20 and the second pin portion 32. Furthermore, a distance 50, measured in the perpendicular direction (arrow 42), between the side surface 20 and an end side 52 of the third pin portion 34 of a connection pin 22 of the lower row 26 is greater than the distance 48. This arrangement ensures that no shading of electrical contact surfaces 36 can occur in an optical test process. The connection pins 22 of the upper and lower row 24, 26 are further designed in such a way that the electrical contact surfaces 36 have a creepage distance sufficient for a predetermined creepage current resistance. The creepage distance is indicated, by way of example, by arrow 54 in FIG. 1.

Reference will now be made to FIG. 2, which shows the device 10 from the viewing direction 42 indicated in FIG. 1. The view shown in FIG. 2 is therefore a view in which the side surface 20 is viewed perpendicularly. As can be seen, the connection pins 22 of the upper row 24 and the connection pins 22 of the lower row 26 are arranged along a respective line. The connection pins 22 of the upper row 24 and the connection pins 22 of the lower row 26 are also arranged offset to each other, as is customary with contact elements of this kind. The connection pins 22 have a constant offset distance 56 along the rows 24, 26, this distance also being referred to as the pitch. The connection pins 22 are arranged such that, for a predetermined creepage current resistance, the abovementioned creepage distance between contact surfaces 36 of closest connection pins 22 is greater than the pitch or offset distance 56 of adjacent connection pins 22. In FIG. 3, which shows a schematic top view of the device 10 of FIG. 1, a further, possible creepage distance between closest contact surfaces 36 is indicated by an arrow 58 by way of example.

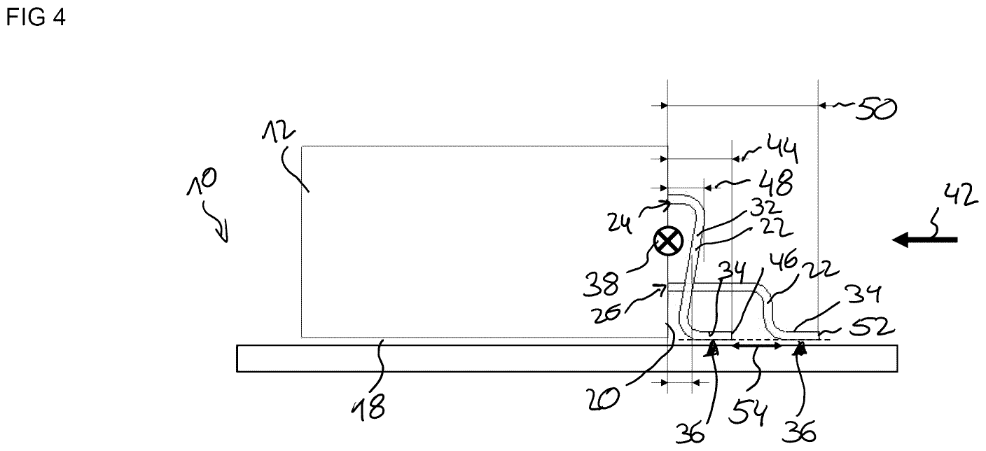

Reference will now be made to FIG. 4. FIG. 4 shows the device 10 with another variant of the contact element 12. FIG. 4 shows the device 10 once again from a viewing direction 38, that is to say parallel to the side surface 20 and along the upper or lower row 24, 26 of connection pins 22. Even in the embodiment of FIG. 4, the connection pins 22 of the upper row 24 intersect with the connection pins 22 of the lower row 26. In contrast to the above-described embodiment of FIG. 1, in the embodiment of FIG. 4 the connection pins 22 of the upper row 24 are formed in such a way that that a distance 48, measured in the perpendicular direction 42, between the side surface 20 and the second pin portion 32 of the respective connection pin 22 decreases in the direction toward the lower surface 18. Owing to this arrangement, the lower end of the connection pin 22 of the upper row 24 moves closer to the side surface 20. As a result, either the creepage distance 54 between contact surfaces 36 closest to each other can be increased or the installation space can be reduced at a specified minimum creepage distance. The “over-bent Z-shape” of the connection pins 22 of the upper row 24 also helps to comply with the above-mentioned coplanarity criterion of the contact surfaces 36. As already described in connection with the embodiment of FIG. 1, a distance 44, measured in the perpendicular direction (arrow 42), between the side surface 20 and the end side 46 of the third pin portion 34 of the connection pin 22 of the upper row 24 is greater than a maximum distance 48, measured in the perpendicular direction (arrow 42), between the side surface 20 and the second pin portion 32. Furthermore, a distance 50, measured in the perpendicular direction (arrow 42), between the side surface 20 and an end side 52 of the third pin portion 34 of a connection pin 22 of the lower row 26 is greater than the maximum distance 48. This arrangement prevents shading of the electrical contact surfaces 36 during an optical test process.

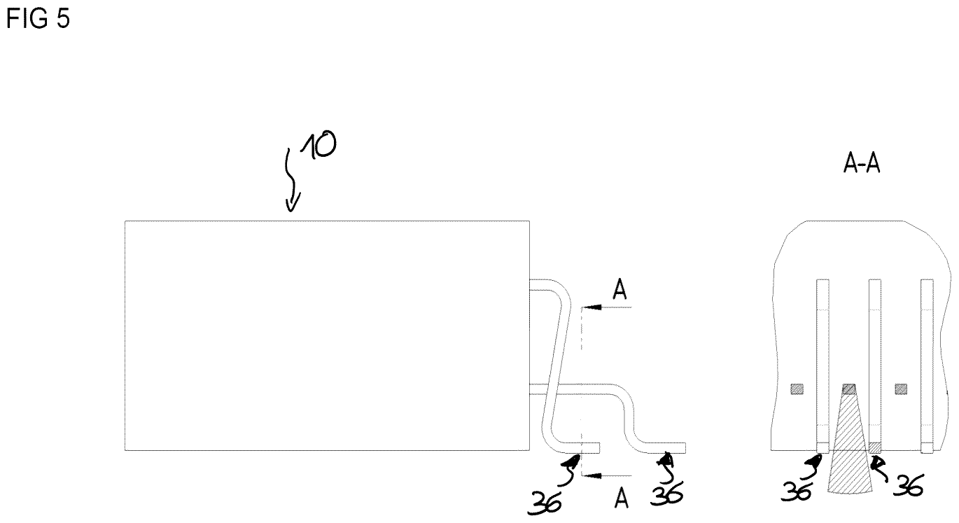

Finally, FIG. 5 shows a schematic sectional view A-A of the device 10 of FIG. 4. For ease of illustration, the electrical contact carrier is not shown in FIG. 5. As can be seen in the sectional view A-A, no shading of the contact surfaces 36 by the connection pins 22 would occur during an optical test process from above. The arrangements of the connection pins 22 described in connection with FIGS. 1 to 4 are therefore particularly suitable for optical test processes in which an optical check of the contact surfaces 36 is performed from above.

1. An electrical contact element, comprising:
a housing with an upper surface, a lower surface opposite the upper surface, and a side surface connecting the upper surface to the lower surface,
a lower row of electrical connection pins protruding from the side surface, and
an upper row of electrical connection pins protruding from the side surface,
wherein, in the viewing direction perpendicular to the side surface, the connection pins of the upper row are arranged offset from the connection pins of the lower row and wherein, in the viewing direction parallel to the side surface and along the upper or lower row of connection pins, the connection pins of the upper row intersect with the connection pins of the lower row.

2. The electrical contact element as claimed in claim 1, wherein the electrical connection pins of the upper row and the electrical connection pins of the lower row each have an electrical contact surface for electrically contacting the respective connection pin with an electrical contact carrier and wherein a creepage distance between the electrical contact surface of a connection pin and the electrical contact surface of the closest connection pin is greater than an offset distance, measured parallel to the side surface, between a connection pin of the upper row and an adjacently arranged connection pin of the lower row.

3. The electrical contact element as claimed in claim 1, wherein the connection pins of the upper row and the connection pins of the lower row each have: a first pin portion which extends from the side surface, a second pin portion which is connected to the first pin portion and extends substantially in the direction of the lower surface of the housing, and a third pin portion connected to the second pin portion, wherein the third pin portion is designed for electrically contacting the connection pin with an electrical contact carrier.

4. The electrical contact element as claimed in claim 3, wherein, in the viewing direction parallel to the side surface and along the upper or lower row of connection pins, the second pin portions of the upper row intersect with the first pin portions of the lower row.

5. The electrical contact element as claimed in claim 3, wherein, in the respective connection pin, the respective third pin portion is arranged parallel to the respective first pin portion.

6. The electrical contact element as claimed in claim 3, wherein, measured in the direction perpendicular to the side surface, a distance between an end side of the third pin portion and the side surface is greater than a maximum distance between the second pin portion and the side surface.

7. The electrical contact element as claimed claim 3, wherein, measured in the direction perpendicular to the side surface, a distance between the side surface and an end side of the third pin portion of a connection pin of the lower row is greater than a maximum distance between the side surface and the second pin portion of a connection pin of the upper row.

8. The electrical contact element as claimed in claim 3, wherein, measured in the direction perpendicular to the side surface, a distance between the second pin portion and the side surface decreases in the direction toward the lower surface of the housing.

9. The electrical contact element as claimed in claim 3, wherein the contact surfaces of the connection pins of the upper row and the contact surfaces of the connection pins of the lower row lie in a common plane.

10. A device, comprising:
an electrical contact element as claimed in claim 1, and
an electrical contact carrier which is electrically connected, in particular soldered, to the connection pins of the electrical contact element.

11. The electrical contact element as claimed in claim 2, wherein the connection pins of the upper row and the connection pins of the lower row each have: a first pin portion which extends from the side surface, a second pin portion which is connected to the first pin portion and extends substantially in the direction of the lower surface of the housing, and a third pin portion connected to the second pin portion, wherein the third pin portion is designed for electrically contacting the connection pin with an electrical contact carrier.

12. The electrical contact element as claimed in claim 4, wherein, in the respective connection pin, the respective third pin portion is arranged parallel to the respective first pin portion.
